(19) United States
(12) Patent Application Publication
(10) Pub. No.: US 2013/0037353 A1
(43) Pub. Date: Feb. 14, 2013

(54) Traction member having traction control

(71) Applicants: Richard PHILLIPS, Fribourg (CH); Daniel SCHOEPKE, Windisch (CH); Tim SCHWARZER, Windisch (CH); Daniel SCHLESIER, Zimmern (DE)

(72) Inventors: Richard PHILLIPS, Fribourg (CH); Daniel SCHOEPKE, Windisch (CH); Tim SCHWARZER, Windisch (CH); Daniel SCHLESIER, Zimmern (DE)

(73) Assignee: BRUGG DRAHTSEIL AG, Birr (CH)

(21) Appl. No.: 13/569,957

(22) Filed: Aug. 8, 2012

(30) Foreign Application Priority Data
Aug. 9, 2011 (CH) 1314/2011

(51) Int. Cl. B66B 7/06; B32B 3/00; B66B 11/08

(52) U.S. Cl. 187/254; 428/212; 428/217; 428/392; 428/377

(57) ABSTRACT

A traction member for use with driving pulleys, consisting of one or more load-bearing elements and a plastics part which is arranged between the load-bearing elements and a force-transmission surface of the traction member. The overall friction value results from the fact that the force-transmission surface, which comes into contact with the driving pulley, has at least two regions, and that these regions are formed from different materials A and B having different coefficients of friction. The regions are in the form of strips in the longitudinal direction of the traction member. The carrier material A is softer and has a higher coefficient of friction and the further materials B1, B2, B3 etc. are each harder and each have a lower coefficient of friction. Preferably, the materials A, B1, B2, B3 etc. are applied in one work step by extrusion.

### TECHNICAL FIELD

The invention relates to a traction member made of load-bearing elements, said traction member having a plastics part which is arranged between the load-bearing elements and a force-transmission surface of the traction member and the friction properties of which can be set in a targeted manner at its force-transmission surface.

### PRIOR ART

In a driving-pulley elevator, a traction member, for example a traction rope or a belt is guided over the driving pulley. The force-transmission surface of the traction member rests on the driving pulley and in the process said traction member forms a particular wrap angle. At one end of the traction member there is a car and at the other end a counterweight. The driving pulley corresponds to a driven roller and transmits the force to the traction member by friction.

For good force transmission, i.e. for good traction, the friction between the driving pulley and the force-transmission surface of the rope is set optimally.

In this case, there is a maximum permissible traction. If this value is exceeded, there is the problem that an empty car, which is already in the top desired position, can be lifted above this position when the counterweight rests fully on the ground/on buffers, specifically on account of the inherent weight of the carrying rope (set-down test). If this occurs, the traction of the system has to be reduced to such an extent that, with the counterweight set down, there is no friction and the driving pulley can spin under the rope without lifting the car further and without forming a slack rope on the counterweight side.

It is therefore important to be able to set the coefficient of friction of the traction member in a targeted manner in a particular range.

WO 2009/127241 A1 (Inventio AG) describes a flat, belt-like traction member made of a plurality of tractive elements that are embedded in a first and a second belt layer. The two belt layers can be formed from the same material or from two different materials. The surface formed in this way can have ribs or be coated with a further substance. However, the coating does not take place in accordance with a particular pattern but over a large area, and nothing is mentioned about different friction properties of the materials.

U.S. Pat. No. 4,904,232 (Mitsubishi) discloses a force-transmission belt having a plurality of ribs which consist of two layers having different Shore hardnesses. The comb of the ribs (inner part) is softer than the base part (outer part) thereof in order to achieve less wear.

JP-2001-317595 and EP 1 510 726 B1 disclose a traction belt having one or more ribs which consist of a plurality of layers (parallel to the longitudinal plane of the belt) such that different materials appear at the outside at the side wall of the rib. On account of the layers incorporated into the rib and emerging at the side wall, the coefficient of friction and thus operating noise are reduced.

DE 20 2008 001 786 U1 (Inventio) describes an elevator carrying belt having V ribs on one side of the belt, wherein the V ribs are intended to engage in corresponding depressions in the driving pulley. On the surface of the opposite side of the belt there are webs made of a material that connects in each case two strands. Between two webs, the surface is formed from an enveloping elastomer material. Thus, longitudinal strips are indeed present on the surface, which, as intended, does not come into contact with the driving pulley.

EP 1 416 082 A1 (Inventio) discloses a synthetic fibre rope having at least two rope strands in a common rope sheath, wherein at least one reinforcing element is provided on the outside on the web between the rope strands. Said reinforcing element serves to mechanically reinforce the rope sheath and is not provided in the regions which are significantly involved in the force fit between the rope and the driving pulley.

It is the object of the invention to create a traction member which belongs in the technical field mentioned at the beginning and in which the coefficient of friction of the force-transmission surface can be set more easily.

The achievement of the object is defined by the features of claim 1. According to the invention, there is provided a traction member which consists of at least one load-bearing element and has a force-transmission surface. This surface has at least two regions. These regions have different friction properties, in particular with regard to their Shore hardnesses, in order to set the coefficient of friction and thus the traction properties of the traction member on a driving pulley. The two regions extend in this case alongside one another in the longitudinal direction of the traction member.

Traction members in the context of the invention are understood to be both ropes and belts. The traction members include at least one load-bearing element or a plurality of tractive or load-bearing elements such as strands and bands which consist preferably of steel. However, load-bearing elements made of other materials such as synthetic fibres or natural fibres, or of a combination of said materials are also conceivable. The load-bearing elements frequently consist of a plurality of fibres or threads which are stranded together or intertwined. However, they may also be formed by wires (made of metal or plastics material) which consist in cross section of a continuous piece of material.

The force-transmission surface is that region of a traction member which comes into contact with a driving pulley such that it can transmit a substantial part of the occurring load-dependent force (called “normal force” in the following text) which is both perpendicular to the longitudinal axis of the traction member and perpendicular to the rotation axis of the driving pulley. This force occurs when the traction member is deflected around the driving pulley, and presses the traction member against the driving pulley. This means that the force-transmission surface is perpendicular to the normal force. This does not rule out the possibility of a drive device having two driving pulleys over which the traction member is guided. The drive force is transmitted from the driving pulley to the traction member by way of the frictional engagement between the driving pulley and the force-transmission surface of the traction member.

In the case of a round traction member, the force-transmission surface, as seen in cross section through the traction member, is circular, i.e. it corresponds to a circular arc (wherein deviations from the circular form on account of the strands used or on account of a deformation/flattening on account of the tensile force are of minor importance). The force-transmission surface can correspond to approximately half the lateral surface of the round rope. Preferably, the force-transmission surface, as seen in cross section through the rope, spans an angular range of 120° with regard to the centre of the round traction member.

In the case of a flat or belt-like traction member which has a plurality of load-bearing elements alongside one another, the force-transmission surface is substantially parallel to the plane which is defined by the load-bearing elements arranged alongside one another. Those surface regions of the belt-like traction member which deviate by an angle of more than 20°, in particular more than 30°, from the plane defined by the load-bearing elements (for example side edges of ribs or undulations in the traction member) are not suitable for transmitting substantial parts of the force and remain out of consideration in the context of the invention. In the case of a traction member which is, for example, rectangular in cross section (belt), the force-transmission surface can be formed by one or by both main surfaces.

The load-bearing elements are arranged under or in the plastics part and do not come into direct contact with the driving pulley. In other words, the plastics part transmits the pressure of the load-bearing elements to the driving pulley.

The force-transmission surface of the plastics part has preferably at least two different regions having different Shore hardnesses. The different regions have to be arranged and configured such that at a particular time they are jointly in direct contact with the driving pulley. It must be ensured that the at least two regions can rest on the driving pulley, i.e. effective contact between the driving pulley and the different regions of the traction member must be ensured. This is the case when two surface regions butt against one another, for example, as seen in cross section through the traction member. A further possibility is that the different regions alternate repeatedly or regularly as seen in the longitudinal direction of the traction member. Overall, it can be stated that the two regions have to extend alongside one another in the longitudinal direction of the traction member. Regions which appear as pure transverse strips, the boundary lines of which thus extend perpendicularly to the longitudinal axis of the traction member, are not according to the invention. Rather, the regions must be delimited from one another such that the boundary line extends at an angle of <90° to the longitudinal direction of the traction member. Preferably, the angle to the longitudinal direction is at most 60° or in particular at most 30°. However, 80° is not ruled out in principle.

In the context of the invention (especially with regard to a belt-like traction member having planar main surfaces) closer observation can reveal that the force-transmission surface of a flat traction member is not actually its entire main surface, which can come into contact in some way with the driving pulley. In this case, the main surface should be considered as a contrast to the lateral narrow surfaces. Rather, it is the sections of the main surface which are located directly between the driving pulley and the respective load-bearing elements. The regions of the main surface that are located between two load-bearing elements, i.e. in the region of a connecting web between two load-bearing elements, do not contribute directly or not substantially to force transmission and can therefore not be included as part of the force-transmission surface in the context of the closer observation. Thus, in the case of a “belt”, the force-transmission surface can be formed by interrupted sections that do not directly adjoin one another. The centre of an individual force-transmitting section can be defined by way of an imaginary line which extends perpendicularly to the main surface through the centre of that load-bearing element of the flat traction member that is located under (or over) the latter.

Overall, these specific (separate) sections (or regions) of the surface have to comprise at least two different regions having different friction properties. Either the different sections, which come simultaneously into contact with the driving pulley, are provided with different friction properties (for example by selection of different plastics materials) or two sub-regions, which come simultaneously into contact with the driving pulley, having different friction properties are provided within a single section.

This is not the same as in EP 1 416 082 A1 (Inventio). In that document, although different regions of the surface consist of different materials, specifically of sheath material and of fibre material that increases the tensile strength, the surface region, which is formed by a different material (specifically the fibre material), is not present between the core longitudinal axis of a load-bearing element and the associated “bearing line” of the traction member. Rather, the fibre material is deliberately placed directly in the web region, i.e. next to the “bearing line”.

By way of a traction member having a precisely set coefficient of friction, it is possible to stop a load, for example an elevator car, in the top position, without having to install further control elements. This simplifies the construction of a lifting device, for example of the elevator, and thus lowers the costs of production, approval/testing and maintenance.

More specifically, it can be stated that in each case a bearing point should be present in each of the at least two regions, said bearing point being defined in that an imaginary straight line passes through the force-transmission surface at a right angle and extends through a centre point of the at least one load-bearing element. In the case of a traction member that is circular in cross section, each radial beam passes through the surface of the traction member at a right angle. The two bearing points can be defined at the same or at a different longitudinal position. In the case of a traction member that is rectangular in cross section, having at least two load-bearing elements located alongside one another, the bearing points (and the associated regions according to the invention having different friction properties) can likewise be defined at the same longitudinal position with respect to different load-bearing elements, or else at different longitudinal positions with respect to the same or different load-bearing elements.

The different regions consist of different materials which differ at least in terms of their physical properties, which have an effect on their friction properties. This means that the materials in the different regions can be chemically similar but differ in terms of their formulation, concentration or degree of crosslinking. However, they may also be materials having different chemical compositions. Different materials in the context of the invention are accordingly materials which differ at least in terms of their friction properties, irrespective of their chemical constitution.

The resulting coefficient of friction can be set precisely by the use of different materials having different Shore hardnesses, which form separate, defined regions on the force-transmission surface.

In addition, the temperature range in which the traction member can be used without the properties of the force-transmission surface changing depending on the temperature is widened by the use of at least two different materials having different physical properties. Suitable materials are elastic solids. If these are polymers, they should preferably be used within their working temperature range, i.e. in a range between their glass transition temperature (T_{g}) and their melting point (Tₘ), since they have the most favourable traction properties or friction values in this range. If two materials are combined with one another, then this can result in a working temperature range which is greater with respect to the individual components.

In a preferred embodiment, the at least two or more materials at the force-transmission surface are in the form of strips. Strips should be understood as being long narrow sections. These extend preferably in the longitudinal direction of the rope. In the case of two materials, the force-transmission surface consists of alternating strips of the two materials. The number of strips depends inter alia on the width of the strips and the dimension of the traction member. A plurality of arrangements of the strips are conceivable when two materials are used. Thus, for example, the two materials can each form 3 to 8 strips. In the case of very large rope diameters, more than 8 strips each are also possible.

The strips extend in the longitudinal direction when they extend from a first longitudinal position (e.g. at the first end of the traction member) to a second longitudinal position (e.g. at the end of the traction member), specifically substantially without interruption. It is not compulsory for the strips to extend parallel to the longitudinal direction, they can also extend in a helical or meandering or undulating manner. It is also not compulsory for the strips to extend along the entire length of the traction member. It is sufficient for them to extend along a substantial section which corresponds, for example, to the working region which is important for the traction of the elevator. Thus, the configuration according to the invention can extend, for example, over a length range of at least 20%, in particular at least 50% and particularly preferably at least 80% of the overall length of the traction member.

In the case of three or more materials, the number of possible combinations increases further. Even multiple strips are then possible. These are strips which are composed of at least two strips made of different materials.

Strips usually have straight edges. However, an undulating design of the strip edges is also possible. However, an embodiment in which the strips are interrupted and correspond to a dashed line is also within the context of the invention. Alternatively, the at least two materials can be arranged in a regular pattern of checks, diamonds or ovals.

The force-transmission surface, which is formed from the plurality of materials, is as far as possible flat and uniform, it has no structures such as grooves, ribs or points. Although it is quite possible for the materials to have microscopic unevennesses, no macroscopic structures such as ribs, grooves, points or the like are formed. The friction properties are affected by the different materials, but not by additional structures.

The coefficient of friction of a surface depends on a number of parameters. Thus, particularly the average roughness Rₐ of the surface, which depends on the application technique, and the Shore hardness of the material play a large role in the context of the invention. However, the resulting frictional engagement is also dependent on the mating component, in this case on the surface of the driving pulley, since it is ultimately a matter of material pairing. Important in this case are the shape of the groove in the driving pulley (V-shaped groove or undercut groove) and the material (steel or cast iron) on which a traction member rests.

The resulting coefficient of friction μ of the force-transmission surface of the traction member is preferably in a range between 0.6 and 0.3. It is thus beneath the currently usual value for plastics-coated traction members of about 1.0. In comparison therewith, a steel rope without a plastics coating has a coefficient of friction of about 0.1-0.2. With this low value, good frictional engagement for continuous force transmission can be ensured only with a corresponding groove shape or a larger wrap angle.

The coefficient of friction that is set should not change over time. Therefore, materials which can move within the plastics part and thus change the friction value of this plastics part should not be used. Very particularly, no components of the plastics part should move onto the force-transmission surface, since they can very considerably affect the frictional engagement with the traction pulley there.

The plastics part, which is located on the traction member and has a force-transmission surface, consists preferably of a carrier material A. The carrier material A establishes a sufficiently stable connection with the load-bearing elements, in that it either completely or partially envelops the latter. Usually, apart from the carrier material A, no further materials of the plastics part are in direct contact with the load-bearing elements.

On the force-transmission surface which is remote from the load-bearing elements, strips made of an additional material B1 are located in the region close to the surface.

However, it may also be advantageous to form a plastics part such that the additional material B1 is located not only in the region close to the surface but extends through the entire plastics part as far as the load-bearing elements.

Optionally, the plastics part also has strips made of different additional materials B1, B2, B3 etc. at the force-transmission surface. The surface can be configured such that a region of the carrier material A is located in each case between the different materials. However, the surface can also have multiple strips made of the different additional materials B1, B2, B3 etc., between which regions of the carrier material A are then located.

Preferably, the carrier material A has a lower Shore hardness compared with the further materials B1, B2, B3 etc. and is thus softer. It also exhibits less abrasion. As a result, the service life of the carrier material A is comparatively high.

By contrast, the additional material B1 is somewhat harder, i.e. it has a higher Shore hardness than the carrier material A. The abrasion of the additional material B1 is higher and as a result its service life is somewhat reduced.

The further additional materials B2, B3 etc., too, behave like the first additional material B1 compared with the carrier material A, i.e. they each have a greater Shore hardness and have higher abrasion than the carrier material A.

However, it can also be advantageous, for example in the case of traction members for use at low temperatures, for the harder component to be the carrier material and for the strips to consist of an additional material having a lower Shore hardness.

The plastics part is preferably formed from thermoplastic elastomers having different coefficients of friction. The thermoplastic elastomers behave like conventional elastomers at room temperature but can undergo plastic deformation when heat is applied.

The thermoplastic elastomers can be thermoplastic polyurethanes (TPUs). TPUs are distinguished by high stability towards hydrolysis and high flexibility at low temperatures. They are resistant to microbes, UV light and to weak acids and bases.

The suitable TPUs (e.g. the Elastollans® of the 1100 Series from BASF) have Shore hardnesses A of 75 to 95. Their Taber abrasion is 20 to 55 mg (1000 g, H-18 wheel). The glass transition temperatures (T_{g}) are in the range of −48 to −28° C. and the Vicat softening points (Tₘ) are between 80 and 127° C.

However, the plastics part can also be formed from thermoplastic polyester elastomers (thermoplastic copolyesters, TPCs). Suitable for this purpose are, for example, block copolymers of polybutylene terephthalate and polyether glycol (Hytrel® from DuPont). Their most important properties include exceptional toughness and flexibility, a high creep strength, impact strength and long-term flexural strength, flexibility at low temperatures and good retention of the property profile at increased use temperatures. They are also resistant to a large number of chemicals, oils and solvents. The Shore hardnesses D are in the range of 35-72. The Taber abrasion is 20-310 mg (1000 g, H-18 wheel) and the Vicat softening points are between 77 and 212° C.

Optionally, the polymeric materials from which the plastics part is formed can contain in each case up to 5% by weight of additives and/or up to 10% by weight of pigments. Depending on the addition, in this way the UV protection is increased, the oxidative degeneration retarded, the stability towards hydrolysis increased or the flame-retardant action enhanced.

In addition to the components which affect the coefficient of friction of the force-transmission surface the traction members optionally contain further components in the load-bearing elements or in the plastics part.

Functional elements such as copper wires, fibre-optic conductors and/or further synthetic fibres can be contained in the traction members.

The plurality of materials which form the plastics part having a force-transmission surface are preferably applied in one work step. This leads to a considerable saving in time and thus costs compared with a multi-stage work process. As a result, inter alia, better adhesion between the materials is achieved and the surface is configured uniformly depending on the type of application. However, in particular cases it can be advantageous to apply the plastics part in a plurality, i.e. in at least two, work steps. Thus, first of all the carrier material A can be applied and in each case a further material B1, B2, B3 etc. in the further work steps.

Preferably, the materials are applied to the load-bearing elements by extrusion. By way of an optimized extrusion process, large quantities of traction members according to the invention can be produced with constant quality in a short time. However, in some cases, it may be advantageous for the plastics part to be applied by a different process, for example by injection-moulding, by dipping the load-bearing elements into a bath containing the carrier material A and subsequently spraying on the additional materials B1, B2, B3 etc. or by completely spraying on or brushing on the materials necessary for the plastics part.

The traction member is preferably a round rope which consists of a plurality of individual strands that are twisted together or intertwined, for example of a core strand and six outer strands. Traction members made of only one strand or having a plurality of strand layers can also be used according to the invention. The traction members consist of the usual materials such as metal wires, natural fibres or synthetic fibres.

In a round rope, the plastics part is in the form of an enveloping sheath. In this case, the carrier material A forms the basis for the sheath. In addition, strips made of at least one other material B1, B2, B3 etc. are arranged in the outer region. The surface of the sheath is level in a preferred form, and it has no significant structures.

The additional material B1 is located preferably in the outer regions of the sheath. This means that the load-bearing elements are enveloped exclusively by the carrier material A and that the additional material B1 is located only up to a particular depth of penetration in the sheath. The cross section of the strips made of the additional material B1 can be round, oval, rectangular or tapering to a point.

There are other embodiments, in which the sheath has regions of the additional material B1 which do not reach as far as the load-bearing elements.

The number of strips depends, inter alia, on the width of the strips and on the diameter of the rope. The strips can all have the same width or different widths depending on the material. However, it is also possible for strips of one material to be present in different widths on a rope. In the case of a sheathing made of two components, thin ropes will have, for example, in each case three or four strips of each material. In the case of thicker ropes, by contrast, in each case six, eight or more strips may be advantageous.

In the case of three materials, the number of possible arrangements of the individual material strips on the surface increases considerably.

Optionally, the traction member is formed in a band-like manner and is present as a flat belt. The band consists of a plurality of spaced-apart strands that are oriented parallel to one another and are fixed in relation to one another by a matrix. The cross section is approximately rectangular. The load-bearing elements consist of metal wires, natural fibres and/or synthetic fibres.

Generally, the load-bearing elements are embedded in suitable materials, for example in plastics materials such as polyamides, polyesters or aramids. In order to increase the coefficient of friction, they are often also enveloped in rubber. If the surface and enveloping thickness are the same on both sides, they can be driven over a driving pulley both by way of the front side and by way of the rear side.

A flat belt according to the invention consists of at least two, overall a plurality of load-bearing elements that are oriented parallel to one another, and it has at least one force-transmission surface, which consists of a carrier material A and at least one additional material B1. The additional material B1 forms strips on/in the carrier material A. A flat belt has two distinguishable sides (front side and rear side). Preferably, the two sides of the flat belt are in the form of force-transmission surfaces, i.e. the front side and the rear side of the rectangular flat belt are formed in accordance with the invention. On both sides there is a carrier material A having strips made of an additional material B1. In the case of a flat belt having two force-transmission surfaces, the carrier material A thus forms a sheathing for the load-bearing elements, and on the surface of the sheathing there are additionally strips made of at least one additional material B1. In this case, the additional material can preferably be the same on both sides, for example B1. However, alternatively, strips of different additional materials B1, B2, B3 etc. can also be embedded in the carrier material A.

In a particularly preferred embodiment, the at least one force-transmission surface of the flat belt has strips which consist of thermoplastic polyurethanes. Optionally, the thermoplastic polyurethanes can contain in each case up to 5% by weight of additives and/or up to 10% by weight of pigments in order to influence the coefficient of friction, or functional elements such as copper wires, fibre-optic conductors and/or further synthetic fibres in the traction members.

Optionally, a flat belt has only one force-transmission surface according to the invention, for example when the flat belt is provided for use with only one driving pulley. One side (for example the front side) is then in the form of a force-transmission surface, i.e. it consists of a carrier material A and has strips of at least one additional material B1. The rear side of the flat belt is formed as desired. Thus, in one embodiment, there is only one layer of carrier material A covering the rope strands, or the strands are only partially embedded in the material and are thus accessible from the outside on the rear side. Optionally, the rear side is coated with any desired material. The arrangement of the strips on the driving pulley contact surface is axial, i.e. the strips extend substantially parallel to the load-bearing elements. Small deviations therefrom, i.e. strip-like regions that extend in a slightly oblique manner, preferably at an angle of 0±5° in relation to the load-bearing elements, are within the scope of the invention. The surface is overall level and has no ribs, undulations, grooves, points or similar structures.

The number of strips depends on the width of the individual strips and on the width of the overall flat belt and can, if necessary, be set individually for both sides.

The traction member according to the invention is suitable for lifting devices having a driving pulley, in which lifting devices the force of a driven driving pulley is transmitted to the traction member by frictional engagement. Thus, the invention also relates to a lifting device having a driving pulley and a traction member according to the invention.

These devices are passenger elevators or goods elevators, high-bay racking, forklift trucks, winches, crane installations, installations for building maintenance, etc.

On account of the use of thermoplastic elastomers for forming the force-transmission surface, applications in extreme conditions are also possible, for example at low temperatures: these include lifting devices in cold stores or cold storage houses, or else traction ropes for snow groomers, which, in addition to the low temperatures, also have to be able to withstand ice, water and snow.

Further advantageous embodiments and combinations of features of the invention can be gathered from the following detailed description and the entirety of the patent claims.

### BRIEF DESCRIPTION OF THE DRAWINGS

In the drawings that are used to explain the exemplary embodiment:

FIG. 1 shows a lifting device having a traction member;

FIGS. 2a, b show side views of traction members on driving pulleys;

FIGS. 3a, b show use temperature ranges for a rope having a) a plastics part made of one material and b) a plastics part made of two materials;

FIGS. 4a-i show cross sections through round ropes having a plurality of components and different strip arrangements;

FIGS. 5a-c show side views of round ropes;

FIGS. 6a,b show a cross section through and a side view of a lifting band;

FIGS. 7a-e show alternative embodiments of lifting bands;

FIG. 8 shows a detailed view of a particular force-transmission surface of a lifting band.

In principle, like parts are provided with like reference signs in the figures.

Ways of Implementing the Invention

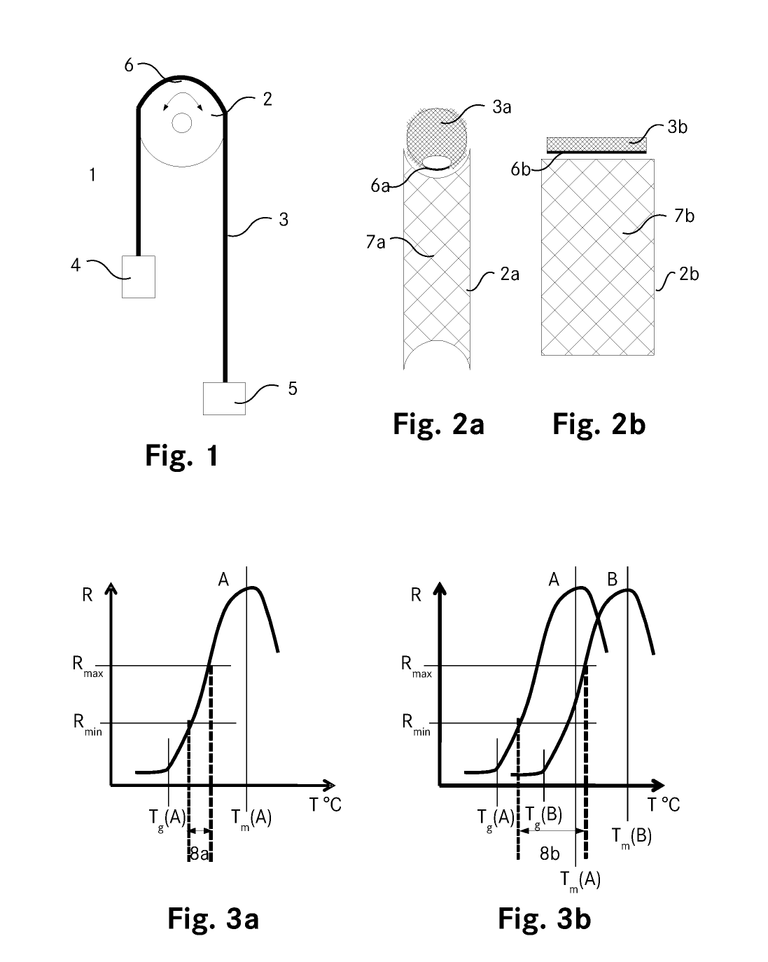

FIG. 1 shows the basic structure of a lifting device 1, for example of an elevator, having a driving pulley 2 and a traction member 3. At one end of the traction member 3 is the weight to be lifted, for example an elevator car 4, and at the other end of the traction member 3 is the counterweight 5. The traction member 3 is not mounted fixedly on the driving pulley 2 but rests by way of its force-transmission surface 6 on the driving pulley 2. The driving pulley 2 is driven by a motor (not shown) and transmits the force to the traction member 3 by frictional engagement.

FIGS. 2a and 2b schematically show cross sections through the driving pulley 2 and the traction member 3. Between the traction member 3 and the driving pulley 2 there is the force-transmission surface 6 of the traction member 3.

FIG. 2a shows a traction member 3a which is in the form of a round rope. The running surface 7a of the driving pulley 2a is curved in a slightly concave manner in order to guide the rope 3a laterally. In the case of a round rope, the force is transmitted in a region which is located under the load-bearing elements in the centre of the rope, i.e. only a part of the sheath forms in each case the currently active force-transmission surface 6a. This region is dependent on the groove shape and the tractive force. FIG. 2b shows the situation in the case of a traction member in the form of a belt 3b. The force-transmission surface 6b extends over the entire width of the belt 3b, i.e. one of the two flat sides of the belt 3b rests fully against the running surface 7b of the driving pulley 2b.

If the belt is guided around two driving pulleys such that first of all one flat side and then the other flat side comes into contact with the running surface of the first and second driving pulley, respectively, then both sides can be embodied as force-transmission surfaces according to the invention having at least two materials.

FIGS. 3a and 3b show that, as a result of the use of two different materials, the temperature range 8 in which the plastics part on the traction member has good traction can be increased compared with a plastics part made of only one of the two components.

FIG. 3a schematically illustrates the dependence of the traction on temperature for the carrier material A. The optimum traction properties are between a minimum friction value Rₘᵢₙ and a maximum friction value These are dependent on temperature and are above the glass transition temperature T_{g}(A) and below the melting point Tₘ(A). T_{g}(A) and Tₘ(A) define the temperature range 8a.

In FIG. 3b, a curve for an additional material B is indicated in addition to the traction properties of the carrier material A. The additional material B has a higher glass transition temperature T_{g}(B) and also a higher melting point Tₘ(B). The temperature range 8b which results from this material combination and in which the traction properties of the two materials are between the minimum value Rₘᵢₙ and the maximum value Rₘₐₓ is larger than the temperature range 8a for the carrier material A. Thus, the traction member can still be used successfully even at temperatures outside the range 8a, for example above the melting point Tₘ(A) of the carrier material A. On account of the combination of the two materials A and B, it is likewise possible to use the traction member below the glass transition temperature T_{g}(B) of the additional material B.

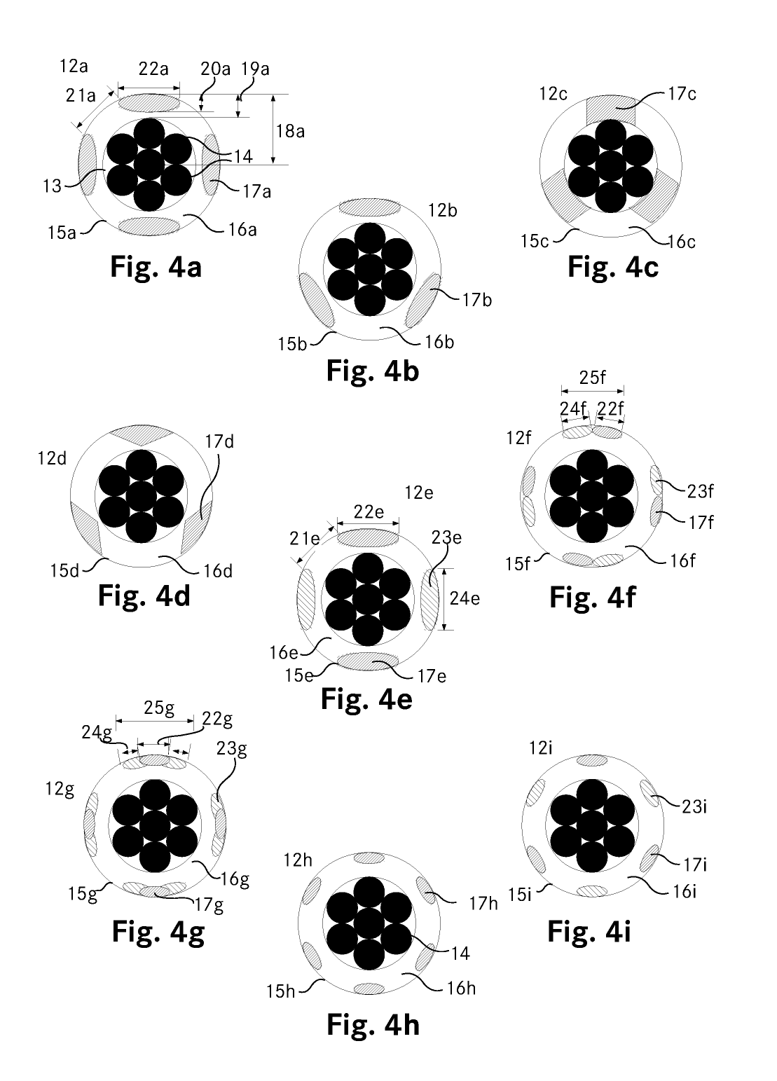

FIGS. 4a-i show cross sections through different traction members 12a-i which are in the form of round ropes, consisting of a core 13 made of seven stranded load-bearing elements 14 and a sheathing 15a-i. The sheathing 15a-i consists in each case of at least two materials, specifically a carrier material A and an additional material B1, B2, B3 etc. The carrier material A forms the basis 16a-i of the sheathing 15a-i and the regions 17a-i are formed by the additional materials B1, B2, B3 etc. The carrier material A is for example Elastollan® 1180A (T_{g}=−40° C., Tₘ=90° C., Shore hardness A=80, Taber abrasion=25), the additional materials B1, B2, B3 are Elastollan® 1185A (T_{g}=−38° C., Tₘ=100° C., Shore hardness A=85, Taber abrasion=30), Elastollan® 1190A (T_{g}=−35° C., Tₘ=120° C., Shore hardness A=90, Taber abrasion=45) and Elastollan® 1195A (T_{g}=−28° C., Tₘ=127° C., Shore hardness A=95, Taber abrasion=55), respectively. FIG. 4a shows the traction member 12a in the form of a round rope, consisting of a core 13 having 7×7 strands 14 made of galvanized steel. The core 13 has a diameter of 1.0 mm to 50 mm. The core 13 has a sheathing 15a which consists of the basis 16a made of a carrier material (A) having four additional strips 17a made of the additional material (B1). The carrier material is Elastollan® 1180A (T_{g}=−40° C., Tₘ=90° C., Shore hardness A=80, Taber abrasion=25), and the additional strips 17a consist of Elastollan® 1190A (T_{g}=−35° C., Tₘ=120° C., Shore hardness A=90, Taber abrasion=45). The traction member 12a has a radius 18a. This is in a range of for example 0.65 mm to 26.0 mm. The radius 18a includes half the diameter of the core 13 and the sheathing 15a, which, based on the layer thickness, corresponds to the maximum layer thickness 19a of the basis 16a. The layer thickness 19a of the sheathing 15a depends on the radius 18a of the traction member 12a and is 0.3 mm to 2.0 mm. In addition, the sheathing 15a has four strips 17a of the additional material B1. The four strips 17a have an oval cross section and have a layer thickness 20a which is less than the maximum layer thickness 19a. The layer thickness 20a of the strips is, for example, 0.2 mm-1.5 mm. The strips 17a of the additional material (B1) are thus in regions close to the surface and butt against the force-transmission surface. They do not take up the entire layer thickness 19a of the sheathing 15a.

Strips 16a and 17a of the carrier material A and of the additional material B1 having the respective widths 21a (carrier material A) and 22a (material B1) can be seen in alternation at the surface of the traction member 12a. The sum of the width of all of the strips corresponds to the circumference U of the traction member. Accordingly, the following applies for traction member 12a: U=(4×21 a)+(4×22 a). At a rope diameter of, for example, 20 mm (U=62.8 mm) and equally wide strips (21a=22a), the strips are about 7.9 mm wide. However, it is not obligatory for the strips to have the same width. Thus, at the same rope diameter of 20 mm, the strips 16a can take up about 60% of the surface (21a>22a) with 21a=9.4 mm and 22a=6.3 mm. FIG. 4b shows a further traction member 12b having a sheathing 15b which consists of the basis 16b made of the carrier material A having three strips 17b of the additional material B1, said strips 17b having an oval cross section. On account of the smaller number of strips on the surface, the widths 21b and 22b thereof change given an otherwise identical rope geometry, i.e. also given an otherwise identical diameter. Thus, the strips 16b and 17b are about 10.5 mm wide at a rope diameter of, for example, 20 mm and equally wide strips (21b=22b). Given a surface proportion of about 60% of the additional material B1 (21b<22b), the strips have a width of about 8.4 mm (strips made of material A) and 12.6 bmm (strips made of material B1), respectively.

FIGS. 4c and 4d depict further embodiments of a round rope, which each have three strips of the additional material B1, having different cross sections. Thus, the strips 17c in FIG. 4c are formed in a manner extending through, i.e. the sheathing 15c of the traction member 12c consists of the segments 16c and 17c which are arranged in alternation and have the same layer thickness, such that the layer thickness 21c corresponds to the layer thickness 22c. In FIG. 4d, by contrast, the core 13 is enveloped entirely by the carrier material A, as in FIG. 4b, but the strips have a different shape in cross section, they taper to a point towards the inside. The strips 17d have a layer thickness 22d which is less than the layer thickness 21d of the entire sheathing 15d.

FIGS. 4e-g depict embodiments of a round rope in which, in addition to the carrier material A and the additional material B1, a further additional component B2 is present. In this case, the carrier material can be Elastollan® 1180A (T_{g}=−40° C., Tₘ=90° C., Shore hardness A=80, Taber abrasion=25), while the strips consist of Elastollan® 1190A (T_{g}=35° C., Tₘ=120° C., Shore hardness A=90, Taber abrasion=45) and Elastollan® 1195A (T_{g}=−28° C., Tₘ=127° C., Shore hardness A=95, Taber abrasion=55).

Thus, the traction member 12e in FIG. 4e corresponds substantially to the traction member 12a in FIG. 4a, wherein strips made of two different additional materials B1 and B2 are formed. Overall, the sheathing 15e consists of the basis 16e and two strips 17e made of the first additional material B1 and two strips 23e made of the second additional material B2. The strips 17e and 23e are present in alternation. The width 22e of the strips 17e can in this case differ from the width 24e of the strips 23e. However, they can also have the same dimensions.

The traction members 12f and 12g in the form of round ropes have, in their sheathings 15f and 15g, multiple strips which consist of two additional materials B1 and B2. Thus, in the sheathing of the traction member 12f (FIG. 4f), the strips 17f and 23f (made of the additional materials B1 and B2) are directly adjacent to one another and together form a double strip having the width 25f as the sum of the individual strips 17f and 23f. The traction member 12g (FIG. 4g) has strips which can be considered to be the sum of three individual strips 23g-17g-23g, i.e. there is a wide strip made of the second additional material B2, which includes a strip made of the first additional material B1. The width 25g of the resulting strip is the sum of the individual strips.

FIG. 4h depicts a further alternative traction member 12h in the form of a round rope, the sheathing 15h of which consists of the basis 16h made of the carrier material A having six oval strips 17h of the additional material (B1). Here, too, the width 21h and 22h of each strip on the surface varies. At a rope diameter of, for example, 20 mm and equally wide strips 16h and 17h, these strips are about 5.2 mm wide. If, for example, 65% of the surface is formed by the carrier material A, then A has six strips having a width of about 6.2 mm, while the strips of the additional material B1 are about 4.2 mm wide.

A traction member having six strips made of two additional materials B1 and B2 is shown in FIG. 4i. In this case, the structure of the traction member 12i, having a sheath 15i consisting of the basis 16i and three strips 17i made of the first additional material B1 and three strips 23i made of the second additional material B2, corresponds to that of the traction member 12h from FIG. 4h.

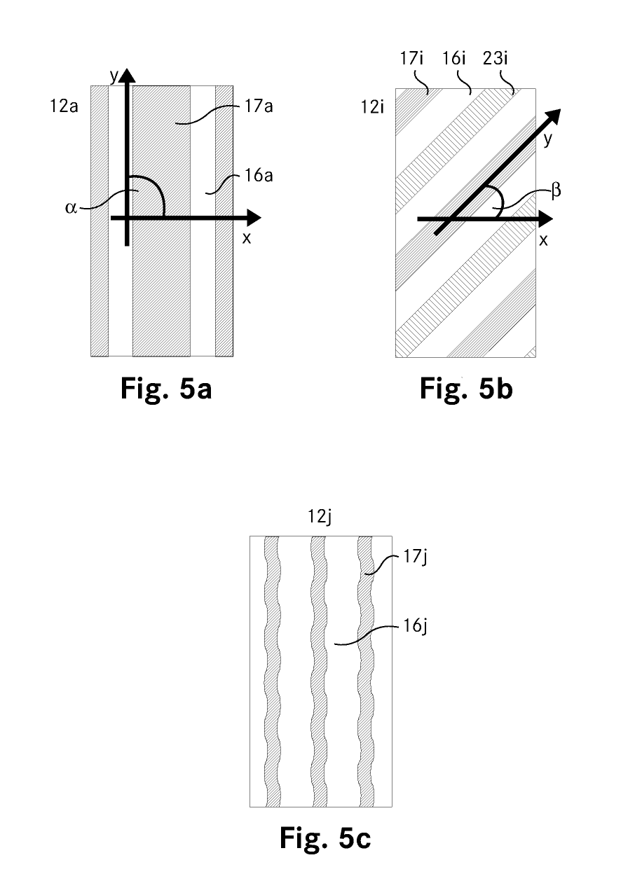

FIGS. 5a-c show the regions made of the additional material or the additional materials on the surface along a rope-like traction member.

FIG. 5a shows the side view of the traction member 12a, in the form of a round rope, having axially extending strips made of the carrier material A and the additional material B1. The strips 16a and 17a extend parallel to the y axis, which forms a right angle (α=90°) with the x axis, wherein the x axis is perpendicular to the rope longitudinal axis.

FIG. 5b shows a helical course of the strips of the traction member 12i. The strips extend along the y axis, wherein the y axis is at an angle β to the x axis. The x axis is perpendicular to the rope longitudinal axis. Preferably, this angle β is between 30° and 70°. It can correspond to the lay angle of the load-bearing elements in the rope.

FIG. 5c shows a further possible embodiment of a round rope. Thus, the edges of the axially arranged strips 17j made of the additional material B1 are formed in an undulating manner on the surface of the traction member 12j.

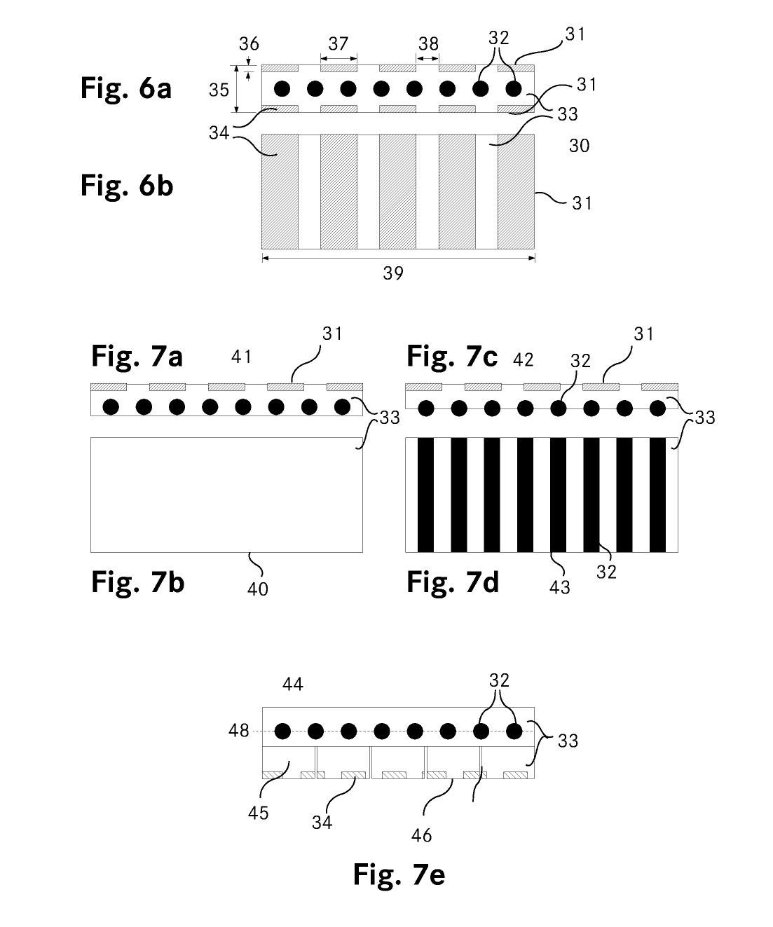

FIGS. 6a, b show a cross section (FIG. 6a) through and a side view (FIG. 6b) of a belt 30 having two identical force-transmission surfaces 31 (top side and underside of the belt).

Within the belt 30 there are load-bearing strands 32 that are arranged in parallel. They consist for example of metal wires and have a diameter in a range of 1.0 mm to 10.0 mm. The strands 32 are embedded in a basis 33 made of the carrier material A. In regions of the basis 33 that are close to the surface, there are arranged strips 34 made of an additional material B1. The band has an overall thickness 35, which is typically between 2.0 mm and 14.0 mm. The strips 34 arranged in the region close to the surface have a rectangular or oval cross section and have a thickness 36 of, for example, 0.3 mm to 1.0 mm. The width 37 of the strips 34 and the width 38 of the strips made of the carrier material A, which are visible from outside, vary in dependence on one another. Their sum corresponds ultimately to the width 39 of the overall band-like traction member 30. The force-transmission surface 31 can consist of equal proportions of carrier material A and additional material. However, the proportion of the additional material B1 can also differ from that of the material A. Material B1 preferably takes up a proportion of 30-70% of the force-transmission surface.

It can be seen in the side view that the strips extend axially along the band 30.

FIGS. 7a-d show cross sections through and side views of alternative embodiments of a band. These embodiments have only one force-transmission surface, their other surface is formed differently.

Thus, one surface 40 of the band 41, the cross section through which is shown in FIG. 7a, can consist exclusively of the carrier material A without an additional material (FIG. 7b), while the other side corresponds to the force-transmission surface 31 according to the invention.

FIGS. 7c and 7d show a band-like traction member 42, in which the load-bearing elements 32 are embedded only partially in the carrier material A 33. Such a belt accordingly has a force-transmission surface 31 according to the invention, while on the other side 43 the individual load-bearing elements are accessible.

FIG. 7e shows the cross section through a band-like traction member 44, the force-transmission surface 46 of which lies on segments 45. The segments are formed such that they form a virtually closed force-transmission surface 46, and the force-transmission surface 46 has the regions according to the invention made of two different materials. The lateral surfaces 47 of the segments 45, in particular the configuration of these surfaces, are immaterial here, since contact is made with a driving pulley exclusively via the force-transmission surface 46. The latter extends substantially parallel to the plane 48 which is defined by the load-bearing elements 32. The belt 44 is produced in an extrusion process, in which the plastics part having the force-transmission surface 46 is formed in one step from the materials A and B1, wherein the carrier material A is, for example, Elastollan® 1180A (T_{g}=−40° C., Tₘ=90° C., Shore hardness A=80, Taber abrasion=25) and the additional material B1 is Elastollan® 1185A (T_{g}=−38° C., Tₘ=100° C., Shore hardness A=85, Taber abrasion=30).

Also possible are bands having two different force-transmission surfaces according to the invention. Thus, one side can correspond to the surface 31 shown, while the other side has other strip widths and/or strips made of a different additional material B2 and/or strips made of a plurality of different materials B1, B2.

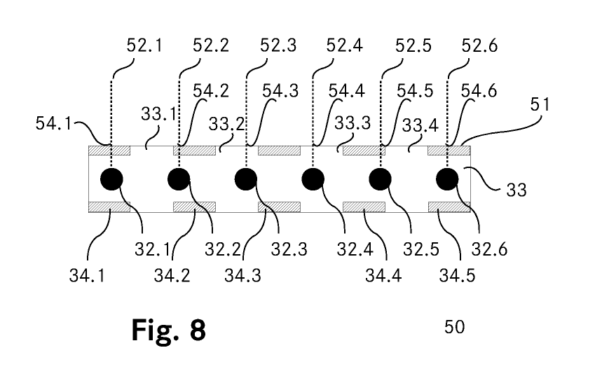

FIG. 8 shows a cross section through a band-like traction member 50 (”belt“) having a force-transmission surface 51. The traction member 50 consists of the load-bearing strands 32.1, . . . , 32.6 arranged parallel to the longitudinal direction, which are embedded in a basis 33 made of the carrier material A. In regions of the basis 33 close to the surface there are arranged strips 34.1, . . . , 34.5 made of an additional material B1. Between the strips 34.1, . . . , 34.5 of material B1, strip-like regions 33.1, . . . , 33.4 of the carrier material A thus occur at the surface of the traction member. The boundary between the regions of material A and of material B1 thus extends in the longitudinal direction, specifically in this case substantially parallel to the longitudinal direction.

If in each case a perpendicular 52.1, . . . , 52.6 is dropped from the centre of the load-bearing strands 32.1, . . . , 32.6 to the force-transmission surface 51, the point of intersection 54.1, . . . , 54.6 of the perpendicular 52.1, . . . , 52.6 with the force-transmission surface 51 represents the region with the greatest loading during the force fit. Because the traction member bears against the driving pulley over a particular length (depending on the wrap angle), each point of intersection 54.1, . . . , 54.6 illustrated in FIG. 8 is assigned a line which has the greatest responsibility for the force transmission. Of course, these lines are to be understood in practice not as mathematically thin lines but as narrow contact strips.

Overall, the band-like traction member 50 is configured such that at least one of the points of intersection 54.1, . . . , 54.6 on the force-transmission surface 51 is located in a region of the carrier material A and at least one other of the points of intersection 54.1, . . . , 54.6 is located in a region made of an additional material B1. In FIG. 8, the points of intersection 54.1, 54.2, 54.5 and 54.6 are located in the region of the strips 34.1, 34.2, 34.4 and 34.5 made of the additional material B1, while the points of intersection 54.3 and 54.4 are located in the region of the carrier material A. Thus, at least two regions having different coefficients of friction are involved in the force fit of the traction member, these being the regions directly over the load-bearing strands 32. (The terms “above” and “below” relate to spatial orientations, as can be gathered from the illustration in FIG. 8. They serve merely to describe the invention more easily, but have no separate technical meaning, because the traction member can take up any spatial orientation in use.) If the material strips extend obliquely to the line of greatest force transmission (analogously to the embodiment with round ropes as shown, for example, in FIG. 5b), the combined action of the two strips (as seen in the longitudinal direction of the traction member) occurs by itself when the traction member runs around a driving pulley.

FIG. 8 illustrates that in each case one bearing point is present in each of the at least two regions, said bearing point being defined in that an imaginary straight line passes through the force-transmission surface at a right angle and extends through a centre point of the at least one load-bearing element.

Optionally, the traction member can be formed such that a plastics part according to the invention having a driving pulley contact surface is present only in a particular length section, and that the traction member is configured in a known manner in all other sections. In the case of a traction member for an elevator, this would be, for example, that section of the traction member which rests on the driving pulley when the counterweight is already virtually in the rest position. The remaining section could then consist exclusively of the carrier material A or of a different material.

A band-like traction member having two driving pulley contact surfaces can optionally have strips of equal width on both sides.

In a further embodiment, the strips have different widths on both sides.

To summarize, there is provided a traction member, the coefficient of friction of which can be set in a desired range by the specific configuration of its surface, in that it has a force-transmission surface having different regions, and these regions consist of different materials having different physical properties.

1.-17. (canceled)

18. Traction member, comprising at least one load-bearing element and a plastics part which is arranged between the at least one load-bearing element and a force-transmission surface of the traction member, characterized in that the plastics part has at least two regions having different friction properties at the force-transmission surface, in order to set the coefficient of friction and thus the traction properties of the traction member on a driving pulley, wherein the two regions extend alongside one another in the longitudinal direction of the traction member.

19. Traction member according to claim 18, characterized in that in each case a bearing point is present in each of the at least two regions, said bearing point being defined in that an imaginary straight line passes through the force-transmission surface at a right angle and extends through a centre point of the at least one load-bearing element.

20. Traction member according to claim 18, characterized in that the at least two regions are formed from different materials (A and B).

21. Traction member according to claim 18, characterized in that the regions at the force-transmission surface are in the form of strips in the longitudinal direction of the traction member.

22. Traction member according to claim 18, characterized in that a coefficient of friction of the traction member at the force-transmission surface is in a range between 0.3 and 0.6 and is constant.

23. Traction member according to claim 18, characterized in that the plastics part consists of a carrier material (A), and in that strips made of at least one further material (B1) are embedded in the plastics part additionally on the force-transmission surface.

24. Traction member according to claim 23, characterized in that the plastics part has strips made of further additional materials (B2, B3 etc.) on the force-transmission surface.

25. Traction member according to claim 24, characterized in that the carrier material (A) is softer than the further materials and has a higher coefficient of friction than the further materials, and the further materials (B1, B2, B3 etc.) are each harder than the carrier material and each have a lower coefficient of friction than the carrier material.

26. Traction member according to claim 20, characterized in that the different materials of the plastics part are thermoplastic elastomers.

27. Traction member according to claim 20, characterized in that the materials each additionally contain up to 5% by weight of synthetic additives and up to 10% by weight of pigments.

28. Traction member according to claim 18, characterized in that the load-bearing elements and the plastics part contain further components for improving the tensile strength or for changing the coefficient of friction.

29. Traction member according to claim 18, characterized in that the load-bearing elements and the plastics part contain further components having additional functions, these further components being in particular copper wires, optical conductors or synthetic fibres.

30. Traction member according to claim 20, characterized in that the different materials (A, B1, B2, B3 etc.) of the plastics part are applied in one work step by extrusion.

31. Traction member according to claim 18, characterized in that it is in the form of a round rope having a plurality of strands, and in that the plastics part envelops the round rope as a sheath, wherein the strips extend axially or helically on the force-transmission surface of the round rope.

32. Traction member according to claim 18, characterized in that it is in the form of a flat belt having a plurality of strands which are arranged parallel to one another, and in that the plastics part is present on at least one running surface of the flat belt, wherein the strips extend in the longitudinal direction of the traction member on the force-transmission surface of the flat belt.

33. Lifting device having a driving pulley and a traction member according to claim 18, wherein the force-transmission surface rests on the driving pulley, wherein regions having different friction properties are present at the force-transmission surface.

34. Lifting device according to claim 33, characterized in that it comprises a passenger car secured to the traction member.
